(19) United States
(12) Patent Application Publication
(10) Pub. No.: US 2014/0081823 A1
(43) Pub. Date: Mar. 20, 2014

(54) TRADING OF FINANCIAL INTERESTS INCLUDING REALLOCATION OF COMMITTED ORDER QUANTITY

(71) Applicant: Bloomberg L.P., New York, NY (US)

(72) Inventors: Kapil Phadnis, Jersey City, NJ (US); Sam Shteingart, New Rochelle, NY (US)

(73) Assignee: BLOOMBERG L.P., New York, NY (US)

(21) Appl. No.: 14/028,437

(22) Filed: Sep. 16, 2013

Related U.S. Application Data
(60) Provisional application No. 61/703,064, filed on Sep. 19, 2012.

(51) Int. Cl. G06Q 40/04

(52) U.S. Cl. CPC G06Q 40/04
USPC 705/37

(57) ABSTRACT

Computer systems, methods, and computer program products are provided for facilitating trading of financial interests over computer networks. A computer system may send through the network a first order for a financial interest, where the first order is not presently executable in an execution venue but has associated with it a quantity that can be committed to a possible future trade. On learning of a possible match between the first order and a second order, the computer system may attempt to firm up the first order into a tradable third order, possibly by asking a trader workstation to recall a quantity that was previously committed to a broker for trading. If firming up succeeds, the third order may be transmitted to a venue for execution. Firming up may include receiving from the trader workstation in formation identifying a broker to give up to the venue.

### CROSS REFERENCE TO RELATED APPLICATION

This application claims the benefit of U.S. Provisional Application Ser. No. 61/291,746, filed Sep. 19, 2012, which is incorporated by reference herein in its entirety.

### LEGAL NOTICES

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

This application contains material relating to the trading of financial interests. The trading of some financial interests is regulated, as for example by the United States Government, various state governments, and other governmental agencies within the United States and elsewhere. The disclosure herein is made solely in terms of logical and financial possibility and advantage, without regard to possible statutory, regulatory, or other legal considerations. Nothing herein is intended as a statement or representation of any kind that any system, method or process proposed or discussed herein does or does not comply with any legal requirement whatsoever, in any jurisdiction; nor should it be taken or construed as doing so.

### BACKGROUND OF THE INVENTION

Participants in financial markets often seek to trade in the venue or venues in which they are most likely to execute their trades and to do so at the best prices possible. Seeking liquidity in one venue may have an opportunity cost, however: sending an order to one venue for execution, directly or indirectly (e.g., by committing the order to a broker, who will seek to trade it), may mean missing an opportunity to trade the order in another. Traders may therefore wish to improve liquidity by reducing this opportunity cost.

### SUMMARY OF THE INVENTION

This application relates generally to trading. More particularly, this application relates to electronic trading of items involving a reallocation of a committed quantity of an order to trade an item committed in one execution venue or to one broker to another execution venue or broker, and/or a reallocation of an uncommitted quantity of an order to trade the item.

The description below refers mainly to financial interests, but the described systems and methods apply equally to anything that can be traded. References to equity financial interests in connection with any specific embodiment or embodiments are solely examples and do not limit the invention, which applies equally to other financial interests and to anything else that trades or is susceptible to trading as described.

Without limiting the foregoing, financial interests suitable for trading according to embodiments of the invention may include, e.g., present, future, and contingent interests such as spot, futures, options, swaps, and forwards contracts. Examples of such interests may include, without limitation, equity instruments such as stocks; fixed-income securities such as corporate, government, and municipal bonds; mortgage-backed securities, collateralized mortgage obligations, loans, commercial paper and other debt instruments; commodities, including for example, energy and precious metals; foreign exchange; derivative and swap instruments; pollution credits; and insurance.

Embodiments of the invention provide a system, method, and computer program product useful in the trading of orders of items involving a quantity or quantities of a respective order not committed to a particular execution venue and/or to a particular broker and/or an uncommitted quantity, and reallocation of such non-committed quantity or quantities for trading at the particular execution venue and/or with the particular broker. For example, an order to buy or sell a financial interest may include at least one quantity committed to possible trading at a particular execution venue and/or associated with or committed to at least one broker, and/or a quantity that is not committed to a possible trade at any execution venue and not associated with or committed to any broker. Regarding an order having at least one quantity committed to at least one broker, such an order may have a quantity committed to one broker or quantities committed to two or more brokers, and such an order may or may not have a quantity or quantities committed to an execution venue or venues.

A quantity of an order not committed to trading at a particular venue or with a particular broker may, as mentioned above, be uncommitted, i.e., not committed for trading at any execution venue or with any broker, or may be committed to trading at an execution venue or venues other than the particular execution venue, or committed to a broker or brokers other than the particular broker.

For ease of description, reference simply to a “committed” quantity or quantities may involve one or more of the aspects of “committed” discussed above. Similarly, for ease of description, reference simply to an “uncommitted” quantity or quantities may involve one or more of the aspects of “uncommitted” discussed above.

For ease of description, an order that is not presently executable in a particular execution venue, but can form the basis of an order that is executable in the execution venue, may be referred to herein as a conditional order with respect to the execution venue, and an order that is presently executable in an execution venue may be referred to herein as a firm order with respect to the execution venue. A conditional order associated with a particular execution venue and/or a particular broker may have a quantity associated therewith based on a quantity or quantities committed to another execution venue or broker (as described above) or an uncommitted quantity (as described above).

The “quantity” in conditional orders for equity interests, in an embodiment, represents the total number of shares available for trading, i.e., both committed and uncommitted, regardless of the number of shares that may have been committed to any particular execution venue or venues, or to any particular broker or brokers.

A reallocation according to the embodiments disclosed herein may involve a reallocation of a committed quantity of an order to trade an item and/or a reallocation of an uncommitted quantity of an item to be traded. Such reallocation may also be referred to as firming up a conditional order.

According to the embodiments disclosed herein, (a) a possible trade is identified between (i) a first order of an item that is not presently executable in an execution venue but has associated therewith a quantity or quantities that can be committed to a possible trade in the execution venue and (ii) a second order for the item either presently executable in the execution venue (e.g., a firm order) or not presently executable in the execution venue (e.g., not a firm order) but having associated therewith a quantity or quantities that can be committed to an order (e.g. firm order) available for a possible trade in the execution venue. Then (b) a determination is made (i) whether to reallocate for commitment to a third order for possible trade in the execution venue a committed and/or uncommitted quantity or quantities related to the first order, and if the second order is not presently executable in the execution venue, (ii) whether to reallocate for commitment to a firm fourth order for possible trade in the execution venue a committed and/or uncommitted quantity or quantities related to the second order, and if the determination is made to reallocate, then (c) a reallocation or firming-up process is initiated.

A reallocation process may include transmitting an invitation to a trader to firm up a conditional order, i.e., provide a firm order with committed quantity related to the conditional order. A trader may respond to an invitation to firm up a conditional order by transmitting a firm order with a desired committed quantity, e.g., the third and/or fourth order referred to above. Committing a desired quantity to a firm order in response to a firm-up invitation may be referred to as “locking up” the committed quantity. (Equivalently, it may be referred to as “locking down” that quantity.)

According to the embodiments disclosed herein, after reallocation is determined relating to the first order and, if applicable, the second order for a possible trade in the execution venue, the firm third order is transmitted to the first execution venue and the firm fourth order, if applicable, is transmitted to the execution venue for possible matching and execution in the execution venue for all or part of committed quantities of the third and fourth orders.

According to the embodiments disclosed herein, matching may occur if prices match or cross or fall within limits, and if quantities meet minimums, etc.

According to the embodiments disclosed herein, one or more of the identification of a possible trade, the determination of whether to reallocate, the reallocation determination and the transmission of an order or orders to the concerned execution venue, uses at least one processor and/or at least one computer or computer system.

According to one or more embodiments, at least conditional orders are stored by a system (referred to below as “liquidity system”) associated with an execution venue in which the orders are conditional and/or are stored by the execution venue. In this embodiment or embodiments, the liquidity system identifies a possible trade between a conditional order and a firm order in the liquidity system or the execution venue, or between two conditional orders in the liquidity system or execution venue. The liquidity system then determines whether to initiate a reallocation or firm-up process with respect to the conditional order or orders in connection with a possible trade in the execution venue. If the determination is made to initiate reallocation, then the liquidity system initiates the reallocation process. Based on various data, discussed in more detail below, the liquidity system seeks to determine a quantity and/or reallocation that attempts to match the quantity estimated or determined to be available on the contra side, or in some way optimize the quantity for the trader who placed the conditional order being firmed up.

According to the embodiments disclosed herein, the liquidity system comprises a data storage device that at least stores conditional orders of parties for the items and may store firm and conditional orders. The concerned execution venue also includes a data storage device that at least stores firm orders of parties for the items and may store firm and conditional orders. According to an embodiment, a matching engine is associated with the concerned execution venue. In another embodiment, a matching engine is associated with the liquidity system. In another embodiment, matching engines are associated with both the concerned execution venue and the liquidity system.

According to the embodiments disclosed herein, a liquidity system may be associated with a single liquidity source (e.g., receive orders from a single liquidity source) and/or be associated with a single execution venue. In accordance with the embodiments disclosed herein, a liquidity system may be associated with a plurality of liquidity sources and/or a plurality of execution venues. A liquidity source may comprise an alternative trading system (ATS), a broker system, an ECN, an exchange, or another venue or system in which orders for trades are stored, aggregated, matched, etc.

A matching engine or engines identifies possible trades between (i) orders stored in the liquidity data storage device, (ii) orders stored in the execution venue storage device, and/or (iii) orders stored in the liquidity data storage device and the execution venue storage device.

According to the embodiments disclosed herein, the liquidity system aggregates orders and a matching engine identifies possible trades between orders including aggregated orders.

According to the embodiments disclosed herein, a conditional or firm order received by the liquidity system may include an association with a sponsoring broker, e.g., the order is committed to the broker. In accordance with the embodiments disclosed herein, each such order must include an association with a sponsoring broker. In some embodiments, a liquidity source may act as a sponsoring broker.

In accordance with the embodiments disclosed herein, a broker-neutral trading environment can be provided. Each trader may designate a broker at least for commission credit purposes, and the execution venue and liquidity system are therefore broker-neutral with respect to trades executed by the execution venue and orders matched and reallocations made via the liquidity system. Order quantity committed to a broker may be reallocated to consummate a trade, but commission credit is given to the broker for the reallocated quantity previously committed to the broker as well as any reallocated uncommitted shares (where the order has shares committed only to that broker). In an embodiment in which an ATS, a venue, or another liquidity source provides firm and/or conditional orders to the liquidity system, the liquidity source may act as the sponsoring broker.

According to the embodiments disclosed herein, where a conditional order has associated therewith quantities committed to more than one broker, a reallocation determination may include identifying the broker or brokers from which quantity is reallocated and the amount of each reallocation and the broker or brokers who are to receive commission credit. In some instances, a broker from whom order quantity was reallocated may not receive broker credit.

According to the embodiments disclosed herein, the execution venue charges a commission for executed trades. According to some embodiments, the liquidity system shares in the commission charged by the execution venue for orders transmitted by the liquidity system to the execution venue.

According to the embodiments disclosed herein, the liquidity system may identify possible trades between firm orders, between firm orders and conditional orders and between conditional orders stored in the liquidity system storage device. According to one such embodiment, the liquidity system receives firm orders committed to an execution venue associated with the liquidity system, and when the liquidity system identifies a potential match between such orders, the liquidity system transmits the orders to the execution venue for execution. When the liquidity system identifies a potential match between a firm order and a conditional order, the liquidity system initiates a firm up process and if the conditional order is firmed up, the liquidity system transmits the firmed-up order and the firm order (if not previously transmitted) to the execution venue for possible execution. According to one or more embodiments, the liquidity system includes logic that can lead a trader (also referred to as a client) to firm up conditional orders when potential contra orders have been found.

According to the embodiments disclosed herein, orders stored in the liquidity system storage device may be based on orders stored in traders′ order management systems (OMSs) or execution management systems (EMSs). Information from orders in an OMS or EMS may be provided to the liquidity system in any suitable way.

According to the embodiments disclosed herein, an execution venue to which committed orders are transmitted or in which committed orders are stored does not disclose or display information regarding pending orders to the public or information regarding pending orders of other parties to parties who have provided orders to the execution venue. Such an execution venue has been referred to as a “dark pool.”

According to an embodiment in which a trader may have relationships with multiple brokers, an embodiment of a firm-up process may includes provision for determining or selecting broker credit for a trade. According to one embodiment, the firm-up process allows the trader to select a broker for credit or apportion credit among two or more brokers.

An embodiment of a method for facilitating trading of financial interests over a network, using at least one computer system that does not execute trades of orders in the financial interest, comprises the at least one computer system receiving through the network (i) a first order for a financial interest that is not presently executable at an execution venue but has associated therewith a quantity or quantities that can be committed to a possible trade in the execution venue and (ii) a second order for the financial interest either presently executable in the execution venue or not presently executable in the execution venue but having associated therewith a quantity or quantities that can be committed to an order available for a possible trade of orders in the financial interest in the execution venue. The method also comprises the at least one computer system determining whether a trade may be possible between an order based on the first order and either an order based on the second order or the second order; if a determination is made that a trade is possible, then the at least one computer system determines (i) whether to reallocate for commitment to a third order for possible trade in the execution venue a committed or uncommitted quantity or quantities related to the first order, and if the second order is not presently executable in the execution venue, (ii) whether to reallocate for commitment to a firm fourth order for possible trade in the execution venue a committed and/or uncommitted quantity or quantities related to the second order.

The method comprises, if a determination is made to reallocate, then the at least one computer initiating a reallocation process which includes transmitting (i) an invitation to a trader associated with the first order to provide the third order with a given quantity and reallocation, and, if the second order is not presently executable in the execution venue, (ii) an invitation to a trader associated with the second order to provide the fourth order with a given quantity and reallocation. And the method comprises the at least one computer transmitting at least one of a received third order, a received fourth order and the second order to the execution venue.

In accordance with the embodiments disclosed herein, the method comprises the at least one computer system determining an allocation for the third order and transmitting the allocation to the trader associated with the first order, and determining an allocation for the fourth order, if applicable, and transmitting the allocation for the fourth order to the trader associated with the second order.

In accordance with the embodiments disclosed herein, where the first and second orders are each associated with a broker, the method comprises the at least one computer system providing a commission to the respective broker if a trade is executed between the third and either the fourth order, if applicable, or the second order.

In accordance with the embodiments disclosed herein, the reallocation process includes (i) determining a quantity for the third order including a reallocation of quantity from the committed and/or uncommitted quantities of the first order, (ii) transmitting an invitation to a trader associated with the first order to provide the third order including determined reallocated quantity and, if the second order is not presently executable in the execution venue, (ii) an invitation to a trader associated with the second order to provide the fourth order.

According to the embodiments disclosed herein, determining a quantity for the third order comprises basing the quantity on market and/or order data for the financial interest.

According to the embodiments disclosed herein, (i) the first order for a financial interest is not presently executable at an execution venue but has associated therewith a quantity or quantities that can be committed to a possible trade in the execution venue and a quantity committed to a plurality of brokers, and (ii) the second order for the financial interest is either presently executable in the execution venue or not presently executable in the execution venue but has associated therewith a quantity or quantities that can be committed to an order available for a possible trade in the execution venue and a quantity committed to at least one broker. A method according to the embodiments disclosed herein comprises: the at least one computer system determining whether a trade may be possible between an order based on the first order and either an order based on the second order or the second order. The method also comprises, if a determination is made that a trade is possible, the at least one computer system determining (i) whether to reallocate for commitment to a third order for possible trade in the execution venue a committed or uncommitted quantity or quantities related to the first order, and if the second order is not presently executable in the execution venue, (ii) whether to reallocate for commitment to a firm fourth order for possible trade in the execution venue a committed and/or uncommitted quantity or quantities related to the second order.

The method also comprises, if a determination is made to reallocate, then the at least one computer initiating a reallocation process which includes transmitting (i) an invitation to a trader associated with the first order to provide the third order with a given quantity and reallocation and also to indicate a quantity to be reallocated from each of the plurality of brokers, and, if the second order is not presently executable in the execution venue, (ii) an invitation to a trader associated with the second order to provide the fourth order. And the method also comprises the at least one computer transmitting at least one of a received third order, a received fourth order and the second order to an execution venue. According to the method, commissions to brokers for a trade are based on a quantity or quantities reallocated from a broker or brokers.

Systems and computer products for carrying out the methods and functionality are further described herein in the context of exemplary embodiments. Such embodiments are disclosed below.

### BRIEF DESCRIPTION OF THE DRAWINGS

The figures of the accompanying drawings are meant to be exemplary and not limiting, and like references in different figures are intended to refer to like or corresponding things.

FIG. 1 is a block diagram depicting an exemplary computer system, e.g., a desktop computer or PC, with which embodiments of a trading system according to the invention may at least partially be implemented.

FIG. 2 is a block diagram depicting an exemplary interconnected network of workstations, e.g., computer systems depicted in FIG. 1, with which embodiments of a trading system according to the invention may at least partially be implemented.

FIG. 3 is a block diagram depicting a network similar to that of FIG. 2 but simplified and showing various exemplary databases and OMSs/EMSs implementing at least partially an embodiment of a trading system according to the invention.

FIGS. 4-7 are diagrams illustrating exemplary flows and relationships between elements of the trading system depicted in FIG. 3.

FIG. 8 is a flow chart showing an exemplary flow of conditional orders into the liquidity system of FIG. 3.

FIGS. 9A and 9B together are a flow chart showing processing of conditional orders by the liquidity system and an execution venue depicted in FIG. 3.

FIG. 10 depicts an exemplary screenshot of a trading screen that may be used to enter and display order information, liquidity system information, and requests to firm up orders.

FIG. 11 depicts an exemplary screenshot of a trading screen that may be used to firm up a conditional order with uncommitted quantity.

FIG. 12 depicts an exemplary screenshot of a trading screen that may be used to firm up a conditional order with a committed quantity.

### DETAILED DESCRIPTION

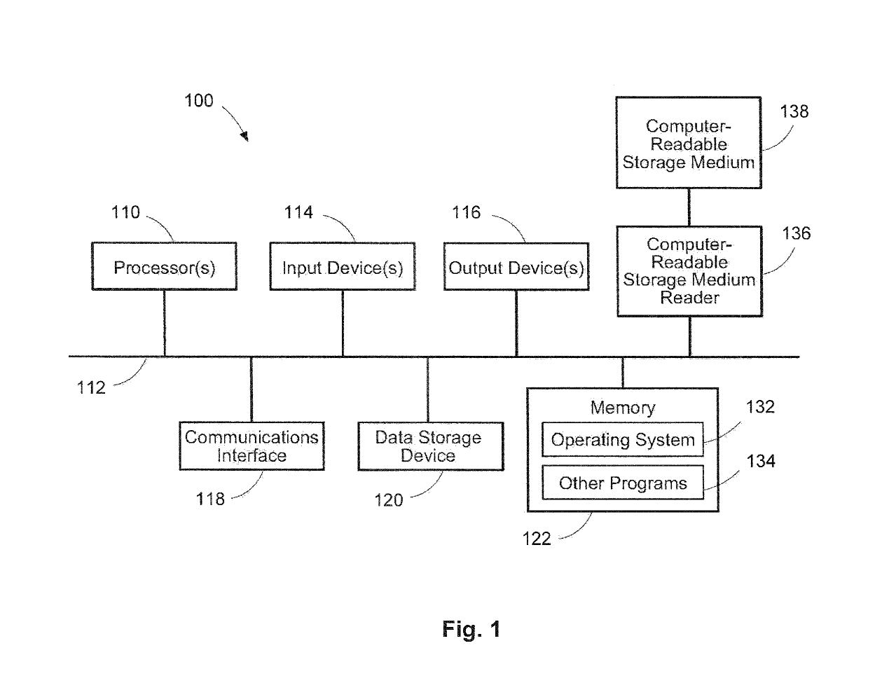

Embodiments of the invention may be implemented by at least one computer system including one or more programmable digital processors. FIG. 1 depicts an example of one such computer system 100, which includes at least one processor 110, such as, e.g., an Intel or Advanced Micro Devices microprocessor, coupled to a communications channel or bus 112. The computer system 100 further includes at least one input device 114 such as, e.g., a keyboard, mouse, touch pad or screen, or other selection or pointing device, at least one output device 116 such as, e.g., an electronic display device, at least one communications interface 118, at least one data storage device 120 such as a magnetic disk or an optical disk, and memory 122 such as ROM and RAM, each coupled to the communications channel 112. The communications interface 118 may be coupled to a network (not depicted) such as the Internet.

It is to be understood that a computer system or systems operable to perform the functionality disclosed herein need not include all of the components mentioned above, and at least one computer system with only some of the components described above may perform such functionality. Such systems may also be referred to simply as computers. The terms “computer system,” “computer,” and “server” are meant in an overlapping and even interchangeable sense as the context may indicate.

Although the computer system 100 is shown in FIG. 1 to have only a single communications channel 112, a person skilled in the relevant arts will recognize that a computer system may have multiple channels (not depicted), including for example one or more busses, and that such channels may be interconnected, e.g., by one or more bridges. In such a configuration, components depicted in FIG. 1 as connected by a single channel 112 may interoperate, and may thereby be considered to be coupled to one another, despite being directly connected to different communications channels.

One skilled in the art will recognize that, although the data storage device 120 and memory 122 are depicted as different units, the data storage device 120 and memory 122 can be parts of the same unit or units, and that the functions of one can be shared in whole or in part by the other, e.g., as RAM disks, virtual memory, etc. It will also be appreciated that any particular computer may have multiple components of a given type, e.g., processors 110, input devices 114, communications interfaces 118, etc.

The data storage device 120 (FIG. 1) and/or memory 122 may store instructions executable by one or more processors or kinds of processors 110, data, or both. Some groups of instructions, possibly grouped with data, may make up one or more programs, which may include an operating system 132 such as Windows 7, Microsoft Windows XP® or Vista™, Linux®, Mac OS®, or Unix®. Other programs 134 may be stored instead of or in addition to the operating system. It will be appreciated that a computer system may also be implemented on platforms and operating systems other than those mentioned. Any operating system 132 or other program 134, or any part of either, may be written using one or more programming languages such as, e.g., Java®, C, C++, C#, Visual Basic®, VB.NET®, Perl, Ruby, Python, or other programming languages, possibly using object oriented design and/or coding techniques.

One skilled in the art will recognize that the computer system 100 (FIG. 1) may also include additional components and/or systems, such as network connections, additional memory, additional processors, network interfaces, input/output busses, for example. One skilled in the art will also recognize that the programs and data may be received by and stored in the system in alternative ways. For example, a computer-readable storage medium (CRSM) reader 136, such as, e.g., a magnetic disk drive, magneto-optical drive, optical disk drive, or flash drive, may be coupled to the communications channel 112 for reading from a CRSM 138 such as, e.g., a magnetic disk, a magneto-optical disk, an optical disk, or flash RAM. Alternatively, one or more CRSM readers may be coupled to the rest of the computer system 100, e.g., through a network interface (not depicted) or a communications interface 118. In any such configuration, however, the computer system 100 may receive programs and/or data via the CRSM reader 136. Further, it will be appreciated that the term “memory” herein is intended to include various types of suitable data storage media, whether permanent or temporary, including among other things the data storage device 120, the memory 122, and the CSRM 138.

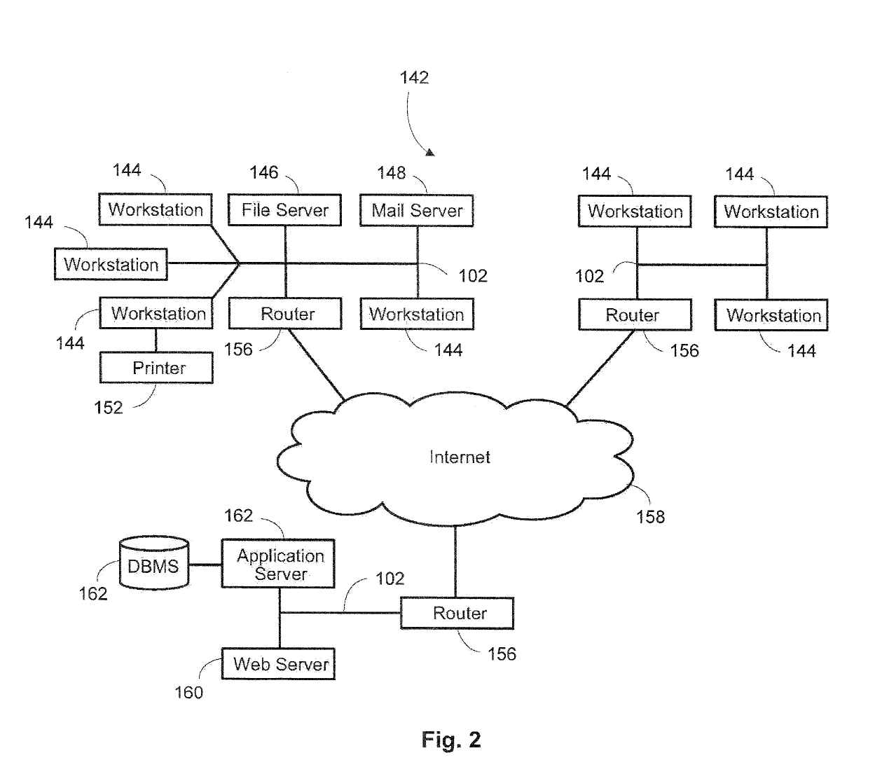

Two or more computer systems 100 (FIG. 1) may communicate, e.g., in one or more networks, via, e.g., their respective communications interfaces 118 and/or network interfaces (not depicted). FIG. 2 is a block diagram depicting an example of one such interconnected network 142. Network 142 may, for example, connect one or more workstations 144 with each other and with other computer systems, such as file servers 146 or mail servers 148. A workstation 144 may comprise a computer system 100. The connection may be achieved tangibly, e.g., via Ethernet® or optical cables, or wirelessly, e.g., through use of modulated microwave signals according to the IEEE 802.11 family of standards. A computer workstation 144 or system 100 that participates in the network may send data to another computer workstation or system in the network via the network connection, and, in some embodiments, via a communications or computer network 158, which may comprise a private network, including leased lines and a router network or networks, and/or a public network such as the Internet, using, for example, the TCP/IP suite of protocols. The network 158 may comprise a closed network (including, e.g., a router network) and/or the Internet. Gateways, firewalls, etc. may provide communication to and from the workstations and systems over the network 158. Gateway, web server, and firewall computers and the functions they perform can be conventional and are not shown in the drawings or discussed in detail.

One use of a network 142 (FIG. 2) is to enable a computer system to provide services to other computer systems, consume services provided by other computer systems, or both. For example, a file server 146 may provide common storage of files for one or more of the workstations 144 on a network 142. A workstation 144 sends data including a request for a file to the file server 146 via the network 142 and the file server 146 may respond by sending the data from the file back to the requesting workstation 144.

Further, a computer system may simultaneously act as a workstation, a server, and/or a client. For example, as depicted in FIG. 2, a workstation 144 is connected to a printer 152. That workstation 144 may allow users of other workstations on the network 142 to use the printer 152, thereby acting as a print server. At the same time, however, a user may be working at the workstation 144 on a document that is stored on the file server 146.

The network 142 (FIG. 2) may be connected to one or more other networks, e.g., via a router 156 and a communications or computer network 158.

An Internet may comprise a network of networks 142 (FIG. 2). The term “Internet” refers to the worldwide network of interconnected, packet-switched data networks that use the Internet Protocol (IP) to route and transfer data.

In the example depicted in FIG. 2, the network 158 provides a communications network over which on or more computer systems in network 142 communicate. For example, a client and server on different networks may communicate via the network 158, e.g., a workstation 144 may request a World Wide Web document from a Web Server 160. The Web Server 160 may process the request and pass it to, e.g., an Application Server 162. The Application Server 162 may then conduct further processing, which may include, for example, sending data to and/or receiving data from one or more other data sources. Such a data source may include, e.g., other servers on the same computer system 100 or LAN 102, or a different computer system or LAN and/or a Database Management System (“DBMS”) 162.

As will be recognized by those skilled in the relevant art, the terms “workstation,” “client,” and “server” are used herein to describe a computer's function in a particular context. A workstation may, for example, be a computer that one or more users work with directly, e.g., through a keyboard and monitor directly coupled to the computer system. A computer system that requests a service through a network is often referred to as a client, and a computer system that provides a service is often referred to as a server. But any particular workstation may be indistinguishable in its hardware, configuration, operating system, and/or other software from a client, server, or both.

The terms “client” and “server” may describe programs and running processes instead of or in addition to their application to computer systems described above. Generally, a (software) client may consume information and/or computational services provided by a (software) server.

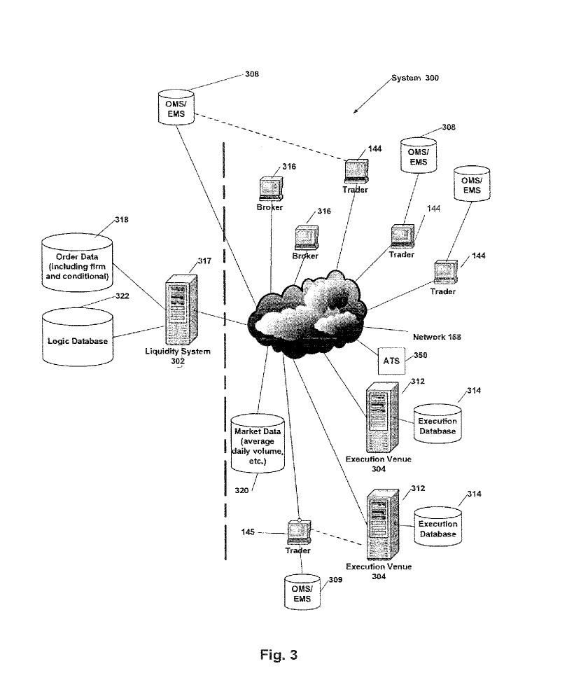

FIG. 3 depicts an embodiment of an electronic trading system 300 for computerized trading of financial interests, e.g., equity interests. The embodiment depicted in FIG. 3 may have many variations in function and configuration, as disclosed herein or evident from the disclosure herein. However, in other embodiments, system 300 may be configured to trade other items. Therefore, description below of specific functionality and configuration is not intended to limit system 300 to only the functionality and configuration expressly disclosed.

System 300 comprises a liquidity system 302 which communicates over a network 158 (e.g., as described above) with at least one execution venue, e.g., execution venue 304 (and may communicate with more than one execution venue as indicated by another execution venue 304). The liquidity system 302 also communicates over the network 158 with a plurality of workstations 144 which may function as trader computer systems (referred to below as “trader workstations”), and workstations 306, which may function as broker computer systems (referred to below as “broker workstations”). Unless the context indicates otherwise, reference to a trader 144 refers to a firm or person performing or having access or authority or permission to perform the indicated functionality or operation via a trader workstation 144, and the like. Similarly, unless the context indicates otherwise, reference to a broker 316 refers to a firm or person performing or having access or authority or permission to perform the indicated functionality or operation via a broker workstation 316, and the like.

The trader workstations 144 may be coupled to a local order management system (“OMS”) or execution management system (“EMS”) 308 (referred to for convenience as an OMS/EMS), or a remote OMS/EMS 308 over the network 158. The execution venues 304 may include a matching and execution system server 312 and a matching and execution database 314 accessed by the respective server 312. The liquidity system 302 may comprise a server 317 and an order database 318 accessed by the server 317. The system 300 may also have access to a database 320 of market data and/or trade data accessed by the liquidity system 302, e.g., via network 158. Such data may include total order quantity, traded volume, e.g., average daily volume of trades of the financial interest, volatility, price change data, etc., and/or order data for the concerned financial interest, e.g., order book volume.

Servers 312 and 317 access programs and data from internal or external storage devices, which are not shown, for carrying out at least the functionality described herein. The workstations 144 and the servers 312 and 317 communicate over the network 158.

Servers 317 and/or 312 may provide for processing and control of information and interfaces to be displayed by a display device(s) of the workstations 144, servers 312 and 317, or such processing and control may be provided via a remote computer or computers implemented as a distributed processing system comprising a node or nodes located local to the workstation(s) and server(s) and a plurality of nodes located remote from the workstations and/or servers, which may include a central location and distributed locations.

The workstations 144 and servers 312 and 317 each may have one or more processors, and have access to memory, which can be shared by various functions of the workstations and servers. Such memory can store a databases or databases and software for the processing and trading functionality performed by a server or workstation.

The workstations 144 and/or servers 312 and/or server 317 may perform various tasks including: (a) loader functions; (b) interpreting data and command inputs; (c) controlling the display of information and interfaces, including providing and controlling the display of market information; (d) trading functions, e.g., routing orders to venues such as execution venues, exchanges, ECNs, ATSs, or to server 312; (e) matching orders for trade execution; (1) receiving market information from sources; and (g) managing a database or databases, etc. The workstations 144 and servers 312 and 317 may perform the functions described above and herein as a host, server or database manager.

Trader workstations 144 may comprise any suitable computer or computer system, e.g., computer system 100, including, for example, desktops, laptops, personal digital assistants (PDAs), local servers, or other computers or data processors, at least one output/display device such as a computer monitor or other output device, and at least one input device such as, for example, a keyboard, a mouse, a touch pad or screen, or other selection or pointing device. According to some embodiments, trader workstations 144 include client software that can interact with server 317 and/or servers 312 to allow users to receive and view data from, and input and transmit data to a server or servers.

Referring to FIG. 3, trader input/output activity can be performed through the use of interactive interface screens displayed on display devices of trader workstations 144, using data provided by, e.g., servers 312 and 317. Input processing may be conducted, e.g., by “point and click” and/or keyboard keystroke methods using items and graphical input fields. For example, tasks associated with displayed items may be selected by either placing a cursor over the item corresponding to the task and activating an instructional address link by activating the “select” switch, or button, or wheel, on a mouse or other pointer, to select the item, or a corresponding number of a menu item may be selected at the command line by using keystrokes from the keyboard to select a corresponding command. For example, a user may enter commands by entering a keystroke combination corresponding to an identifier such as a number associated with a listing in a menu. Data may be input by placing the cursor over a desired input field, which may be identified by associated text displayed with the input field, and activating a pointer switch to select the field, and typing data in from the keyboard. Thus input functions are typically accomplished in embodiments such as the one described by positioning a cursor within (“pointing” to) a desired image area and activating a control switch on a mouse (“clicking”) to select an item associated with the image area, or analogous functioning of other pointing devices.

Referring to FIG. 3, a trader via a workstation 144 may enter an order or orders into an OMS/EMS 308 in a number of ways, e.g., manual entry of individual orders, electronic entry of orders from a spreadsheet or other electronic document via user input operations (e.g., drag and drop), or electronically, e.g., automatically or in response to user input, from electronic storage, e.g., in files, records, etc.

A trader system OMS/EMS 308 (FIG. 3) can be configured to mirror all orders tradable in the execution venue 304 or a subset or subsets or classes of orders tradable in the execution venue to the liquidity system 302 associated with the execution venue 304 automatically upon entry into the OMS/EMS, individually or as part of a batch. In some embodiments, orders not automatically mirrored to liquidity system 302 can be manually selected for transmission to liquidity system 302. For example, order parameters may include in a particular message or record field an indication that the order is to be mirrored to the liquidity system 302.

In an embodiment, traders 144 must select at least one broker 316 (FIG. 3) as a sponsor in order to participate in trading at a particular execution venue 304 via liquidity system 302, but may select more than one broker 316. Traders can commit an order or a quantity of an order to a broker for trading at an execution venue 304 via the liquidity system 302.

The sponsor broker 316 (FIG. 3) with which a trader 144 has a relationship also has a relationship with the execution venue 304, e.g., through sponsor access agreements. In an embodiment, the liquidity system 302 may serve as an intermediary between a sponsor broker 316 and an execution venue 304. The liquidity system 302 may also send orders to an execution venue 304, or pull (i.e., reallocate) committed order flow from an execution venue or broker, or pull an uncommitted order quantity from a broker, as discussed in more detail below. In some embodiments, liquidity system 302 may also perform matching of conditional and/or firm orders of traders 144 associated with liquidity system 302. Conditional and/or firm orders of traders 145 not associated with liquidity system 302 (as indicated by the broken line between trader workstation 145 and execution venue 304) may be matched by execution venue 304 with which liquidity system 302 and the trader 145 are associated.

In addition, in one embodiment, an ATS 350 may transmit firm or conditional orders, e.g., “book” orders,” to liquidity system 302. In this embodiment, the ATS acts as a sponsoring broker.

Liquidity system 302 (FIG. 3) may hold both firm orders, which may be executed in execution venue 304 to which they are committed as such, and conditional orders, which cannot as such be executed. As described below, trader 144 can reallocate quantity to create a firm order related to the conditional order with respect to a particular execution venue 304, or in other words, convert a conditional order to a firm order. Such reallocation may also be referred to as “firming up” an order. The use of conditional orders may allow liquidity system 302 to improve liquidity by including orders and/or order quantity that are not committed to the particular execution venue.

In one embodiment, the liquidity system 302 (FIG. 3) includes a matching engine, which looks for any firm or conditional orders already stored in the liquidity system order database 318, or newly stored in the database, that can form the basis for a trade. If it finds such orders, the liquidity system 302 may then initiate a firm-up process for any conditional order that can form the basis of a possible trade. If a firm order or orders are provided in response to a firm-up process, the liquidity system 302 transmits matched firm orders to execution venue 304 for possible matching and possible execution.

When orders that were not matched by liquidity system 302 are made available to an execution venue 304 by liquidity system 302, execution venue 304 may match a conditional order with a firm order or a conditional order from traders 144 associated with liquidity system 302 and/or traders not associated with liquidity system 302, e.g., external traders 145 and/or ATS 350, etc. When the execution venue 304 finds such a match, it may, e.g., send to the liquidity system 302 a notification of the match.

In response to learning of a match including a conditional order and another order, either by liquidity system 302 or an execution venue 304, liquidity system 302 initiates a process to firm up the conditional order. Various systems and methods, possibly employing various algorithms, may be provided to firm up a conditional order.

According to one embodiment, liquidity system 302 may transmit an invitation or request to the trader workstation 144 from which the conditional order was received to firm up the conditional order. That trader workstation may respond by transmitting a firm order with a desired committed quantity to liquidity system 302. Committing a desired quantity to a firm order in response to a firm-up invitation may be referred to as “locking up” the committed quantity (or, equivalently, “locking down” that quantity). The matching engine of the liquidity system 302 may attempt to match the firm order with another order in the order database 316, or may transmit the firm order to the execution venue 304 associated with the other order. Where liquidity system 302 matches two firm contra orders, liquidity system 302 may transmit a single, two-side order to execution venue 304 for execution.

According to another embodiment, liquidity system 302 initiates a firm-up process which provides a firm-up invitation to the trader workstation 144 from which the conditional order was received to firm up the conditional order with a committed quantity (i.e., provide a firm order with the committed quantity). The trader associated with trader workstation 144 has the option of firming up the conditional order with a desired quantity manually or automatically in accordance with an algorithm. As discussed above, firmed-up quantity may be reallocated from committed or uncommitted quantity.

According to another embodiment, liquidity system 302 initiates a firm-up process which includes determination of a firm-up quantity, and provides a firm-up invitation to the trader workstation 144 from which the conditional order was received to firm up the conditional order with the determined committed quantity. The firm-up process may determine a firm-up quantity automatically using market and/or trade order data, or interactively with the trader 144. The trader associated with trader workstation 144 has the option of firming-up the conditional order with the determined quantity manually or automatically in accordance with an algorithm.

In an embodiment, liquidity system 302 calculates the quantity to request based on the associated trader's order trading data, e.g., total order quantity, traded volume, etc., and/or trading data for the concerned financial interest, e.g., traded volume and/or untraded order book volume, volatility, price change data, etc.

According to one embodiment, the reallocation calculation is based on the total volume of the trader's order and the average daily volume of trades of the concerned security. For example, if a particular financial interest tends to trade in high volume, the order quantity may be relatively small to minimize the potential effect of the order on market prices. Conversely, for a less-heavily traded financial interest, the order quantity may be relatively large, in an attempt to maximize the likelihood of trading all the quantity in the order.

Based on data relating to the particular trader, and/or data relating to trading of the particular financial interest and/or orders to trade the particular financial interest, and/or market data, and/or financial data relating to the particular financial interest, the liquidity system 302 seeks to determine a quantity and/or reallocation. The quantity or reallocation determined may be considered optimal based on this data and information, preferences and/or data relating to the particular trader.

According to some embodiments, the quantity or reallocation that is determined may reflect an attempt to match the quantity available on the contra side, if that quantity is available to the particular trader to commit; and if that quantity is not available, the quantity or reallocation may be the full quantity available to the particular trader to commit, up to the full quantity estimated or determined to be available on the contra side, which could be considered optimal for a particular trader. The quantity available on the contra side may not be known or available to the liquidity system, which attempts to estimate or determine this quantity based on information that is available to the liquidity system, such as the information mentioned above.

The firm-up invitation to trader 144, including any calculated quantity, may appear, e.g., in a pop-up window on the display of the trader workstation 144. An invitation to firm up may be indicated in one or more other ways in addition to such a pop-up window or instead of it. For example, one or more visual, auditory, or haptic signals may also be provided. (It will be appreciated that one or more such signals may also be provided instead of, or in addition to, any other pop-up described herein.)

In other embodiments, the trader workstation 144 may be configured to respond to requests automatically, e.g., based on pre-defined logic or rules.

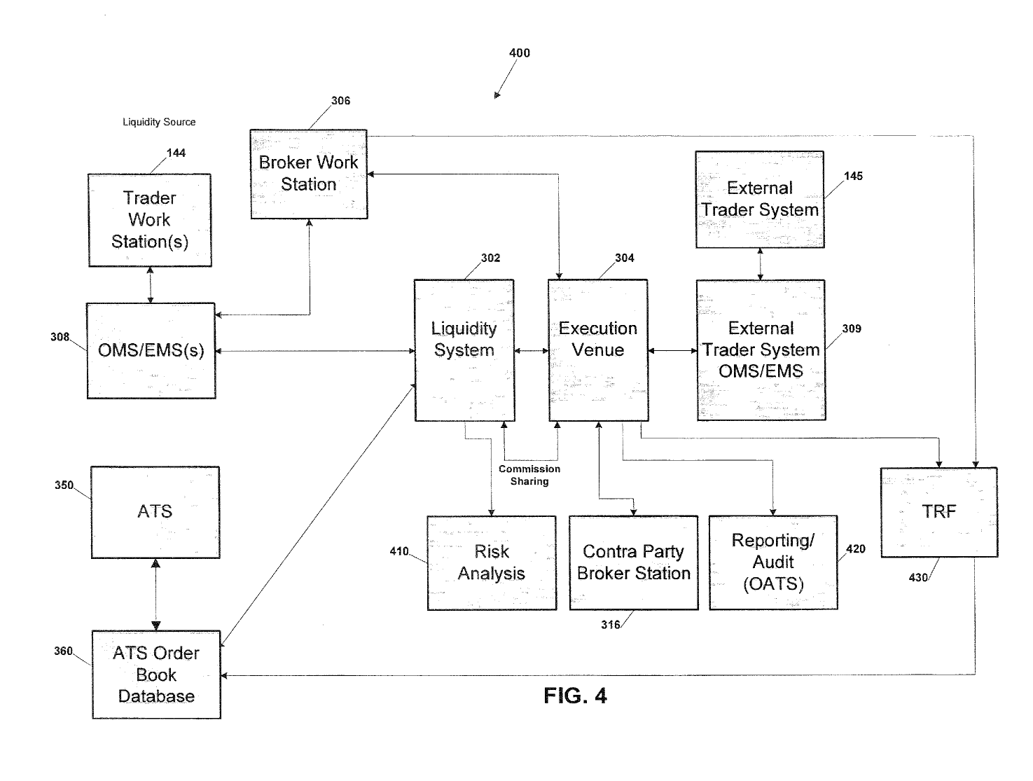

FIG. 4 depicts a simplified diagram of the relationships, according to one embodiment, among a trader OMS/EMS 308, a trader workstation 144, a broker workstation 306, the liquidity system 302, and a single execution venue 304. (For simplicity, the network 158, additional trader workstations and OMS/EMSs and some other elements shown in FIG. 3 are not shown in FIG. 4.) The diagram of FIG. 4 also shows a risk analysis module 410 which conducts risk analysis of orders transmitted to liquidity system 302. In addition to matching orders and executing trades of orders, execution venue 304 may provide trade data to an Order Audit Trail System (“OATS”) 420, which reviews compliance of possible trades with securities regulations, e.g., with Rule 15c3-5, and report orders to brokers 316, and to a Trade Reporting Facility (TRF) 430.

As depicted, a trader 144 associated with a local or remote OMS/EMS 308 has a relationship with a broker 306. The trader 144 makes available orders on the OMS/EMS 308 to the broker 316. Such orders may include conditional orders only, firm orders relative to the execution venue 304 associated with the liquidity system 302, or both conditional and firm orders.

A variation of the embodiment depicted in FIG. 4 discussed so far provides for conditional and firm orders to be transmitted directly to liquidity system 302 from an alternative trading system (ATS) 350 without a sponsoring broker, in which case, the ATS may act as the sponsoring broker. In one version of this variation, the liquidity system 302 and the ATS 350 may be operated by the same organization or related organizations, and the ATS 350 may act as the sponsoring broker for orders it transmits to the liquidity system 302. The ATS 350 may simply provide for firming up a conditional order with or without any reallocation. Liquidity sources and venues other than an ATS may also provide orders to liquidity system 302 and either act as brokers or have relationships with brokers.

In an embodiment such as FIG. 4 depicts, a plurality of trader work stations 144 may be associated with a plurality of respective OMSs/EMSs 308 that are hosted by a common service or entity. The common service may be the sole liquidity source to the liquidity system 302. In a variation, ATS 350 (FIG. 4) may also act as a liquidity source to liquidity system 302. The liquidity sources may be associated with a single entity.

In an embodiment such as FIG. 4 depicts, the liquidity system 302 may be associated with a single execution venue 304. In one embodiment, as depicted in FIG. 4, the liquidity system is associated with a single liquidity source represented by OMSs/EMSs 308 (with a possible variation of ATS as another liquidity source), and a single execution venue 304.

The liquidity source and the liquidity system may be operated by the same entity. In such an embodiment, that entity may offer, e.g., a service that hosts both one or more OMSs/EMSs and the liquidity system 302.

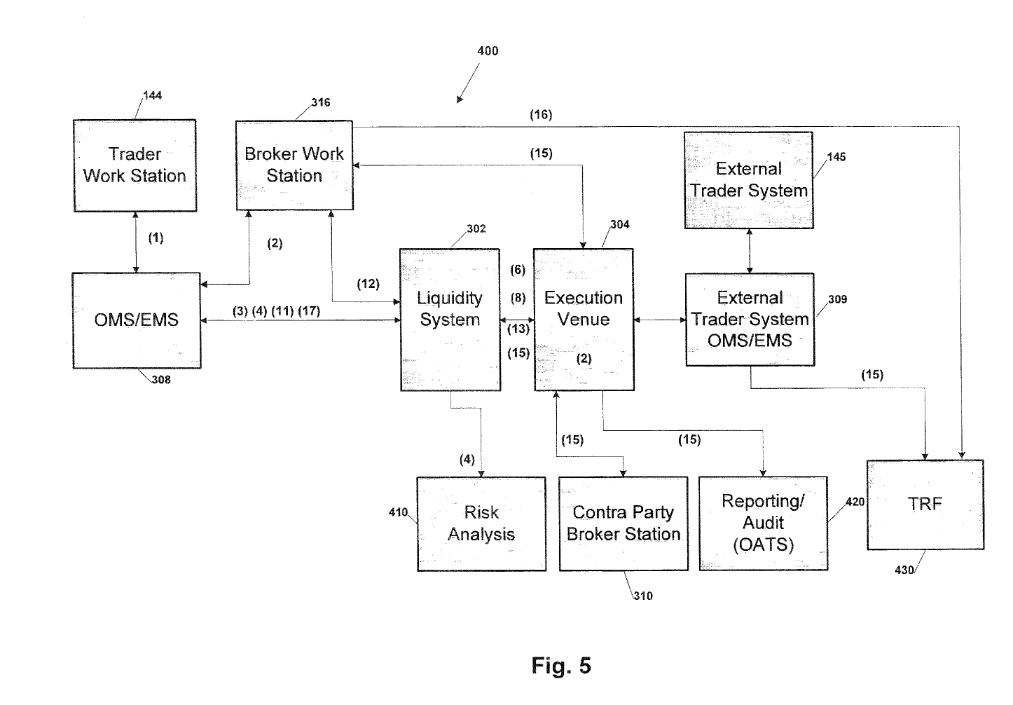

FIGS. 5-7 depict exemplary flows for orders, matching, firm-up, reporting, etc. based on simplified diagrams of FIG. 4 and variations.

As discussed above, a broker-neutral trading environment can be provided in which each trader must designate a broker at least for commission credit purposes. Order quantity committed to a broker that is reallocated to consummate a trade may be credited to the broker receiving the reallocated quantity and broker from whom order quantity was reallocated may not receive broker credit.

If a trader workstation 144 in such an environment has relationships with multiple sponsoring brokers 316, in an embodiment of the trading system of FIG. 4, the trader workstation 144 can choose which of the brokers 316 is to receive credit for the trade. (Identifying the broker to liquidity system 302 and execution venue 304 may be referred to as “giving up” that broker.) The trader workstation 144 may select this broker based, e.g., on the “broker-vote budget”, which reflects the trader's plans for compensating brokers for brokerage and for additional services such as analysts' research. Those skilled in the art will recognize that other logic or rules may be used to select which broker is to receive credit for a trade.

As discussed in more detail below with respect to FIG. 5, the trading system 400 of FIG. 4, in an embodiment, operates to allow a trader workstation 144 to reallocate order quantity committed to one broker 316 (“broker A”), i.e., pull quantity from broker A, in order to complete an order with another broker (“broker B”), if necessary. For example, if some or all of the order quantity to be traded in an order for which credit is to be given to broker B has been committed to broker A, the trader workstation 144 may try to pull back some of the committed shares by sending a cancel/replace message to broker A.

If quantity has been committed to more than one execution venue or broker 316, the trader workstation 144 may receive a pop-up window that asks for selection of a method, e.g., first in, first out (“FIFO”), last in, first out (“LIFO”), or pro rata, etc., for deciding what quantity is to be pulled from the respective execution venues or brokers. In such an embodiment, trader workstation 144 and/or liquidity system 302 may automatically attempt to pull the quantity that corresponds to the selected order. For quantity that has not been committed, the trader workstation 144 confirms that the quantity remains available for trading, converts the conditional order to a firm order and pulls the uncommitted quantity, if necessary.

According to some embodiments, once quantity has been pulled (if it has been necessary to do so), trader workstation 144 may send a message back to liquidity system 302 to confirm that the quantity to be committed in a firm order has been locked down. (It is possible for a trader workstation 144 to lock down less than the quantity that has been requested by liquidity system 302, even if such quantity is available to trade.) Liquidity system 302 may then forward a firm order with a committed quantity set or confirmed by the trader to execution venue 304. After determining the quantity that can be traded (based, e.g., on the firmed-up quantity on both sides, execution venue minimum quantities, etc.), execution venue 304 executes the orders and reports the trade.

The liquidity system 302 and/or the associated execution venue 304 may include anti-gaming rules governing traders′ responses to firm-up invitations, and may penalize traders who fail to satisfy such rules or who engage in unsatisfactory conduct defined by such rules.

For example, reliance by others on the trader workstation 144 to firm up a matched conditional order and provide a related firm order, may create an opportunity for traders to game the system. For example, a trader may enter a conditional order, intending only to see whether interest exists on the other side, but not to trade, and then to modify their trading strategies to reflect this information. To prevent this, penalties can be imposed on traders 144 who do not meet rules regarding firming up of conditional orders. For example, a non-performing trader may be temporarily barred from the further use of liquidity system 302 or execution venue 304. Anti-gaming logic and enforcement may be handled by liquidity system 302, execution venue 304, or a combination of the two.

In an embodiment, a commission sharing arrangement may be in place between liquidity system 302 and execution venue 304. The commission sharing arrangement may reflect, e.g., liquidity system 302 providing liquidity to the execution venue and firming up the conditional orders. FIG. 4 illustrates this embodiment with a line between liquidity system 302 and execution venue 304 labeled “commission sharing.”

FIG. 5 depicts an example of a flow of orders and execution reports for a particular equity stock where the trader has committed shares to only one broker. In this example:

(1) Trader workstation 144 via OMS/EMS enters an order to sell 100.000 shares of IBM stock with 50,000 shares committed to broker 316 and 50,000 shares uncommitted;

(2) A message is transmitted to broker 316 committing 50,000 shares to broker 316;

(3) A conditional order for 100,000 shares is transmitted to liquidity system 302;

(4) Module 410 performs risk analysis;

(5) Liquidity system 302 searches for a match for a possible trade of the conditional order and does not identify a match;

(6) Liquidity system 302 transmits the 100,000 share conditional order to execution venue 304;

(7) execution venue 304 identifies a match for a possible trade of up to 100,000 shares with an existing firm or conditional order or orders in execution venue 304 from liquidity system 302, external trader system OMS/EMS 309 or an ATS (not shown in FIG. 5);

(8) execution venue 304 transmits a message to liquidity system 302 informing of the possible match for up to 100,000 shares with an existing firm order or orders;

(9) liquidity system 302 makes a determination, as described herein, whether to reallocate for commitment to a firm order for a possible trade in execution venue 304 all or part of the 50,000 shares committed to broker 316 and/or all or part of the 50,000 uncommitted shares, and determines that 60,000 shares should be reallocated to a firm order for a possible trade with 60,000 shares in execution venue 304 (a different number of shares could also have been determined);

(10) Liquidity system 302 transmits an invitation to trader 144 to firm up 60,000 shares reallocated as follows: 50,000 from broker 316 and 10,000 from uncommitted (other reallocations are also possible);

(11) Trader 144 accepts the invitation and locks down 60,000 shares and transmits a firm order for 60,000 shares to liquidity system 302;

(12) liquidity system 302 transmits a message to broker 316 to release 50,000 shares;

(13) liquidity system 302 transmits the firm order for 60,000 shares to execution venue 304;

(14) execution venue 304 matches two firm orders for 60,000 shares and executes the trade;

(15) execution venue transmits trade data (e.g., execution report (EX)) and a new order report (NW)) to OATS 420, TRF 430, broker 316, contra party broker 310 and liquidity system 302;

(16) broker 316 transmits trade data to TRF 430; and

(17) liquidity system 302 transmits trade data to OMS/EMS 308.

In the above example, up to 100,000 shares were identified in execution venue 304 for a possible trade, but this number could have been only 60,000 shares or less, in which case liquidity system 302 could have made a different reallocation determination. Also, in a variation, the trader could have designated the number of shares to trade and determined the reallocation. For example, the trader could have set 70,000 shares to trade with whatever allocation the trader wanted.

In an embodiment where shares have been committed to more than one broker, trader workstation 144 may receive a pop-up window (and/or another indicator, e.g., as described above) that asks for selection of a method, e.g., first in, first out (“FIFO”), last in, first out (“LIFO”), or pro rata, etc., for deciding which shares are pulled back from the respective brokers. In such an embodiment, the trader may designate what quantities of shares are pulled back from which broker or brokers.

Messages, firm and conditional orders, invitations may be transmitted in the FIX protocol, and a FIX message for an order may include data for the order type (conditional or firm), ticker, side, quantity, broker ID and a price.

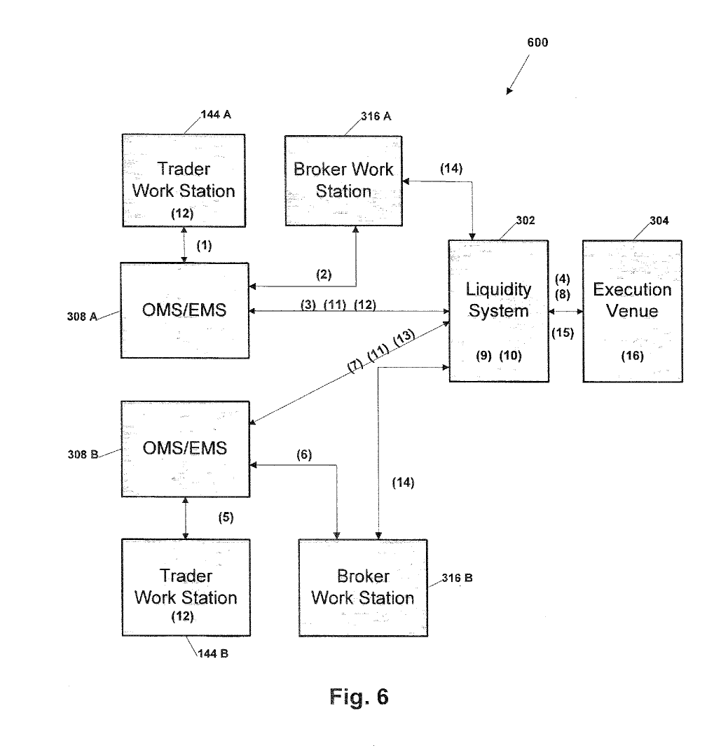

FIG. 6 depicts an example of a flow of orders for a particular equity stock where two traders 144A and 144B have a relationship with liquidity system 302 and transmit conditional orders thereto, each of which include shares committed to a respective broker 316A and 316B. This example does not show the risk analysis module and the flow of execution reports for reasons of clarity and simplification. In this example:

(1) trader workstation 144A via OMS/EMS 316A enters an order to sell 100,000 shares of IBM stock with 50,000 shares committed to broker 316 and 50,000 shares uncommitted;

(2) a message is transmitted to broker 316 committing 50,000 shares to broker 316;

(3) a conditional order to sell 100,000 shares is transmitted to liquidity system 302;

(4) liquidity system 302 forwards the conditional sell order for 100,000 shares to execution venue 304;

(5) trader workstation 144B via OMS/EMS 316B enters an order to buy 60,000 shares of IBM stock committing all 60,000 shares to broker 316 B;

(6) a message is transmitted to broker 316B committing the 60,000 shares to broker 316B;

(7) a conditional order to buy 60,000 shares is transmitted to liquidity system 302;

(8) liquidity system 302 forwards the conditional buy order for 60,000 shares to execution venue 304;

(9) liquidity system 302 identifies a match for a possible trade of 60,000 shares;

(10) liquidity system 302 makes a determination, as described herein, whether to reallocate for commitment to respective firm orders for a possible trade in execution venue 304 of all or part of trader 144A's committed 50,000 shares and uncommitted 50,000 shares and/or all or part of trader 144B's 60,000 shares committed to broker 316B, and determines that traders 144A and 144B should both allocate to respective firm orders and lock down 60,000 shares each;

(11) liquidity system 302 transmits an invitation to traders 144A and B to firm up 60,000 shares each reallocated as desired;

(12) trader 144A locks down 50,000 shares from broker 316A and trader 144B locks down 60,000 shares from broker 316B;

(13) Trader 144A and trader 144B each transmits a firm order for 60,000 shares to liquidity system 302;

(14) liquidity system 302 transmits messages to broker 316A and 316B to release 50,000 and 60,000 shares, respectively;

(15) liquidity system 302 transmits the firm orders for 60,000 shares to execution venue 304;

(16) execution venue 304 matches two firm orders for 60,000 shares and executes the trade.

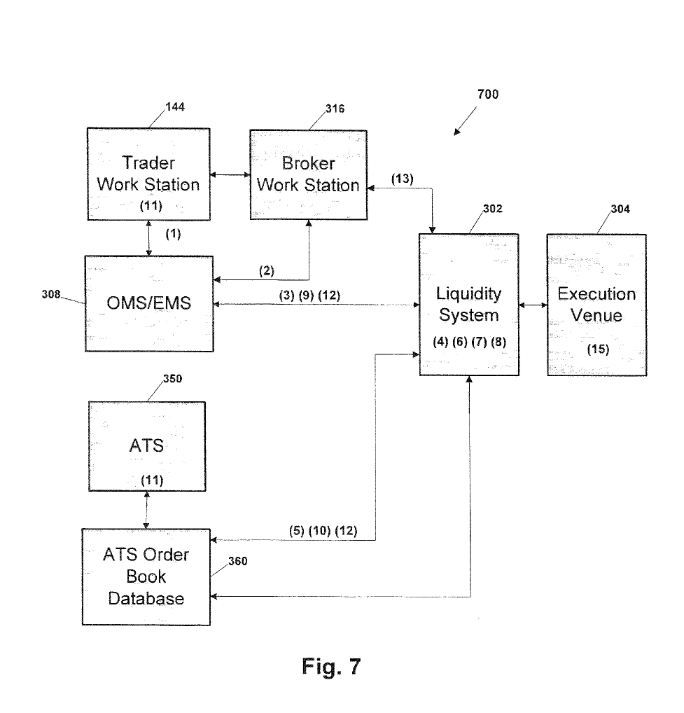

FIG. 7 depicts an example of a flow of conditional orders in an exemplary embodiment, wherein trader 144 has a relationship with a sponsor broker 316, and an ATS 350 submits orders from its order book database 360 to the liquidity system 302 without a sponsoring broker. This example does not show the risk analysis module and the flow of execution reports for reasons of clarity and simplification. In this example, the ATS 350 acts as the sponsoring broker.

In the embodiment depicted in FIG. 7, generally, trader workstation 144 sends a first conditional order to broker 316, which transmits the first conditional order to liquidity system 302. ATS 350 sends a second conditional order directly to liquidity system 302. According to one embodiment, liquidity system 302 conducts matching to determine the possibility of trades based on orders in the liquidity system order database 318 (FIG. 3).

More specifically, according to an embodiment, upon receipt of the first and second conditional orders, liquidity system 302 holds the orders for possible aggregation and does not immediately send either order to execution venue 304. Instead, liquidity system 302 holds both others until internal logic, e.g., a “smart order router,” determines that the orders should be routed to execution venue 304. The smart order router may send the first conditional order alone; the second conditional order alone; or send firmed-up orders based on the first and/or second conditional order; or route either or both the first or second conditional orders or firmed-up orders with a third conditional or firm order. Orders matched or aggregated for possible trade by liquidity system 302 may be sent to execution venue 304 in a single two side message. Orders are firmed up as described above.

The flow in this example is summarized below.

(1) trader workstation 144A via OMS/EMS 308A enters an order to sell 100,000 shares of IBM stock, committing 50,000 shares to broker 316 and 50,000 shares uncommitted;

(2) a message is transmitted to broker 316 committing 50,000 shares to broker 316;

(3) conditional order to sell 100,000 shares is transmitted to liquidity system 302;

(4) liquidity system 302 holds the conditional sell order for 100,000 shares for aggregation with other orders from traders 144 (not shown in FIG. 7);

(5) ATS 350 transmits a conditional order to buy 60,000 shares of IBM stock from its order book database 360 to liquidity system 302;

(6) liquidity system 302 holds the conditional buy order for 60,000 shares for aggregation with other orders from ATS 350;

(7) liquidity system 302 identities a match for a possible trade of 60,000 shares between the conditional 100,000 share sell order and the conditional 60,000 share buy order;

(8) liquidity system 302 initiates a reallocation process with respect to the conditional 100,000 share sell order of trader 144, and makes a determination, as described herein, whether to reallocate for commitment to a firm sell order for a possible trade in execution venue 304 of all or part of the 50,000 shares committed to broker 316 and all or part of the 50,000 uncommitted shares, and determines that trader 144 should allocate to a firm order and lock down 60,000 shares, 50, 000 of which is from the uncommitted quantity and 10,000 of which is from the quantity committed to broker 316;

(9) liquidity system 302 transmits an invitation to trader 144 to firm up a 60,000 share sell order with the reallocation above;

(10) liquidity system 302 transmits an invitation to ATS 350 to firm up a 60,000 share buy order;

(11) trader 144 and ATS 350 each lock down 60,000 shares;

(12) trader 144 and ATS 350 each transmit firm contra orders for 60,000 shares to liquidity system 302;

(13) liquidity system 302 transmits a message to broker 316 to release 50,000 shares;

(14) liquidity system 302 transmits the firm contra orders for 60,000 shares to execution venue 304 in a single two side message;

(15) execution venue 304 executes a trade of the two 60,000 share contra orders.

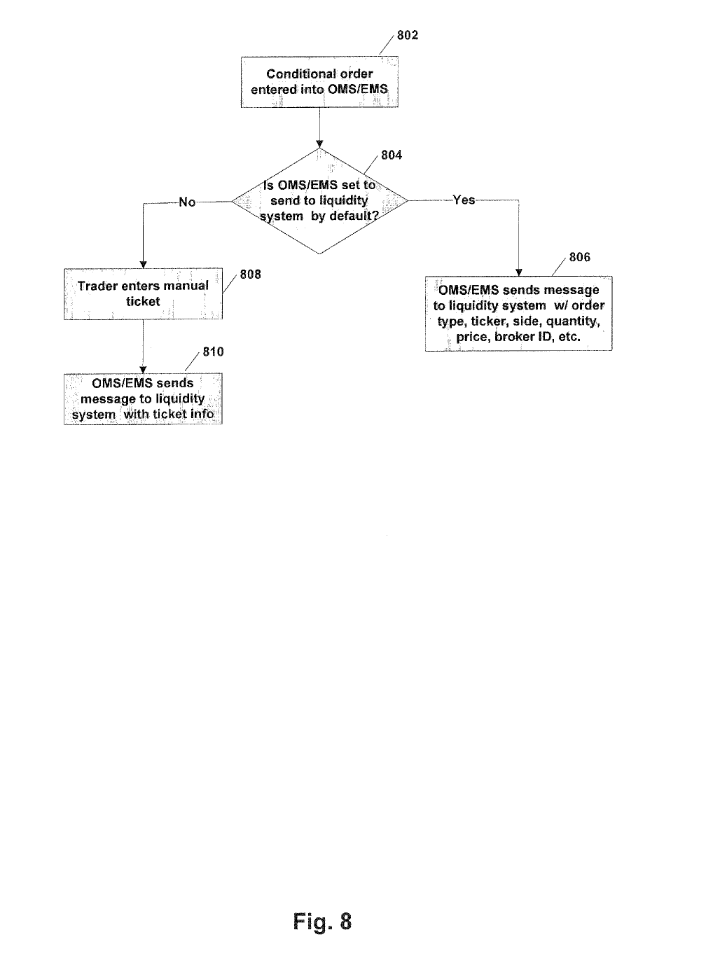

FIG. 8 depicts a flow of conditional orders in an exemplary embodiment in which a trader may send orders to liquidity system 302 by default/automatically, or manually. In one embodiment, trader 144 may have configured an OMS/EMS so that all orders designated for liquidity system 302 are mirrored automatically to liquidity system 302 upon entry into the OMS/EMS, unless specifically indicated otherwise. In another embodiment, trader 144 may set a default so that orders are not automatically mirrored to liquidity system 302, but may then manually select one or more orders from the OMS/EMS to send to liquidity system 302.

Specifically, in FIG. 8, block 802, a conditional order is entered into an OMS/EMS. The OMS/EMS, in block 804, checks whether the OMS/EMS is set to send orders to liquidity system 302 by default. If the OMS/EMS is set to send orders to the liquidity system 302 by default, then the OMS/EMS, in block 806, sends the order to the liquidity system 302, e.g., via a FIX message with parameters that may include order type (conditional or firm), ticker, side, quantity, broker ID and a price. If the OMS/EMS is not set to send orders by default to the liquidity system 302, then in block 808 the trader workstation 144 may enter a manual ticket for an order, which is sent to liquidity system 302 in block 810.

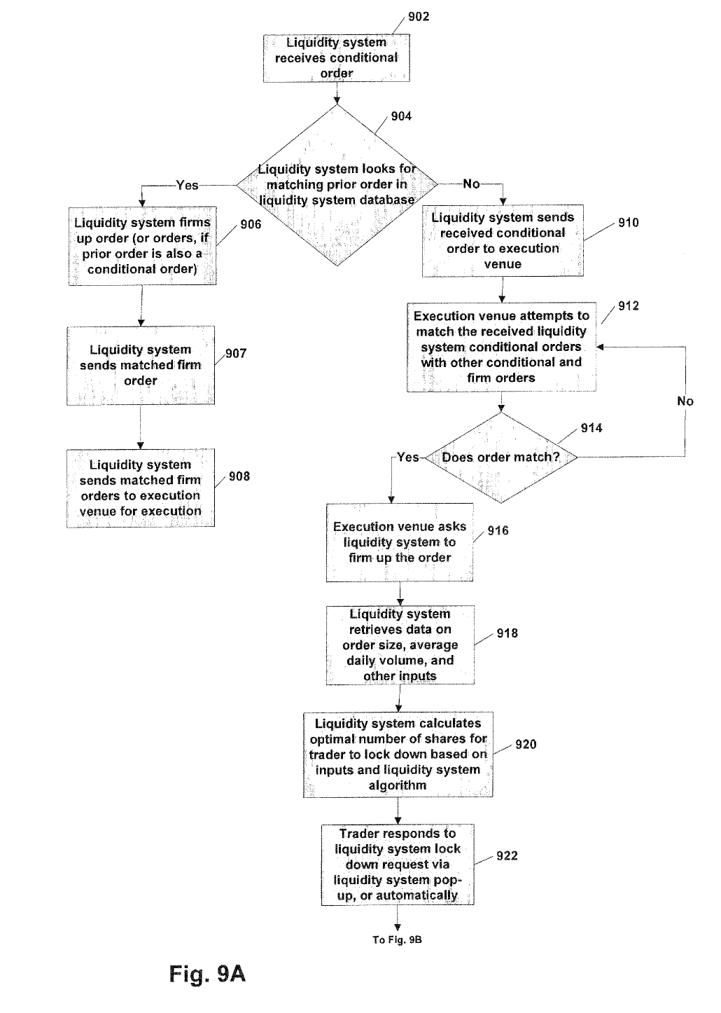

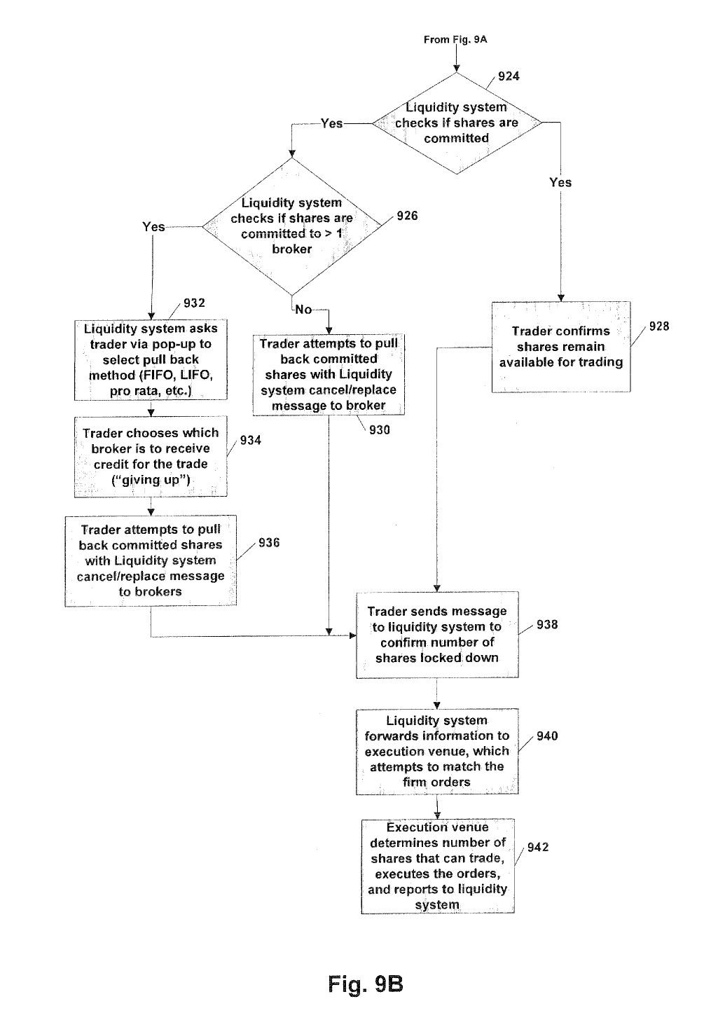

FIGS. 9A and B depict a flow of conditional orders in an exemplary embodiment starting with receipt of a conditional order by liquidity system 302. In block 902 of FIG. 9A, liquidity system 302 receives a conditional order, e.g., as disclosed herein or as would be evident from the disclosure herein.

In block 904, liquidity system 302 searches for a matching prior order in its database. If liquidity system 302 finds a match, liquidity system 302 may attempt to firm up the order (or orders, if the prior order is also a conditional order) in block 906. Firm orders received in block 907 by liquidity system 302 are sent in block 908 to execution venue 304 for execution.

In block 910, conditional orders that were not matched by liquidity system 302 in block 904 are made available to execution venue 304 from liquidity system 302. In block 912, execution venue 304 may match a firm order or another conditional order or orders from other trading venue traders, e.g., external traders 145 or an ATS, shown in FIGS. 3 and 4. If execution venue 304 does not match the order, the order may remain with execution venue 304 until a match can be found, or until the close of trading day, or until canceled. In some embodiments, an unmatched order may be canceled immediately.

If in block 914 execution venue 304 matches a conditional order from liquidity system 302, it notifies liquidity system 302 to firm up the order at 916. In block 918, liquidity system 302 retrieves information, e.g., from databases 318, 320, and/or 322 (FIG. 3), comprising information relating to order size, average daily volume, and other inputs, e.g., market trends, historical information etc.

Based on the information retrieved from databases 318, 320, and/or 322, or based on or in combination with other information or proprietary algorithms in various embodiments, liquidity system 302 in block 920 calculates an order quantity for the trader to reallocate or “lock down” and sends a message to the trader workstation 144 inviting the trader to commit that quantity in a firm order, as described above. For example, if a particular security tends to trade in high volume, the order size may be relatively small to minimize the potential effect of the order on market prices. Conversely, for a less-heavily traded security, the order size may be relatively large, in an attempt to maximize the likelihood of trading all the shares in the order.

The invitation to trader workstation 144 to lock down shares may appear to the trader workstation 144 as a pop-up window (and/or another indicator, e.g., as described above) on the trader's display. In such an embodiment, in block 922, the trader may respond to the lock down request manually. In other embodiments, the trader's system may be configured to respond to requests automatically, e.g., based on pre-defined logic or rules.

In block FIG. 9B, 924, liquidity system 302 checks if the shares required for the trade are committed to a broker. If the shares are not committed to a broker, in block 928, the trader workstation 144 confirms that the shares remain available for trading (either manually; automatically; or as part of the lock-down request of block 922), and order flow continues to block 938, discussed below.

If, in block 924, the liquidity system 302 determines that shares have been committed, the liquidity system 302 functions to allow a trader to pull back shares from one or more brokers to complete a trade (per blocks 930 and 932 discussed below).

For example, in an embodiment where shares are committed only to a single broker, as determined by block 926, trader workstation 144 attempts in block 90 to pull back committed shares by sending a cancel/replace message to the broker, and order flow continues to block 938, discussed below.

If shares have been committed to more than one broker, as determined in block 926, the trader workstation 144 in block 932 may receive a pop-up window (and/or another indicator, e.g., as described above) that asks for selection of a method, e.g., FIFO, LIFO, or pro rata, etc. for deciding which shares are pulled back from the respective brokers. In block 936, trader workstation 144 attempts to pull back committed shares by sending a cancel/replace message to the appropriate broker(s), and order flow continues to block 938, discussed below.

Alternatively, pulling back may be fully automatic, taking place invisibly to the user. It may be governed, e.g., by the user's custom settings.

According to some embodiments, trader workstation 144 may decide to direct credit for a trade to a particular broker. As discussed above, identifying such a broker to liquidity system 302 and execution venue 304 may be referred to as “giving up” that broker, and may be based on the “broker-vote budget” reflecting the trader's plans for compensating brokers for brokerage and for additional services such as analysts′ research, or based on other logic or rules. The “giving up” selection may occur, in some embodiments, in block 934 as depicted in the flow of FIG. 9B. However, those skilled in the art will recognize that selecting which broker is to receive credit for a trade may occur earlier or later in the flow of a conditional order.

In block 938, if any shares that have been pulled back (if it has been necessary to do so), then trader workstation 144 may send a message back to liquidity system 302 to confirm the number of shares that have been locked down, as it is possible for a trader workstation 144 to lock down fewer shares than has been requested by liquidity system 302, even if those shares are available to trade. Liquidity system 302 may be enabled to forward the information to execution venue 304 in block 940, which may attempt to match the firm orders in block 942. After execution venue 304 has determined the number of shares that can trade in block 942 (based, e.g., on the number of firmed-up shares on both sides), execution venue 304 executes the orders and reports the trade, e.g., to liquidity system 302, trader workstation 144, and/or any of the trade reporting facilities or auditing facilities discussed herein.

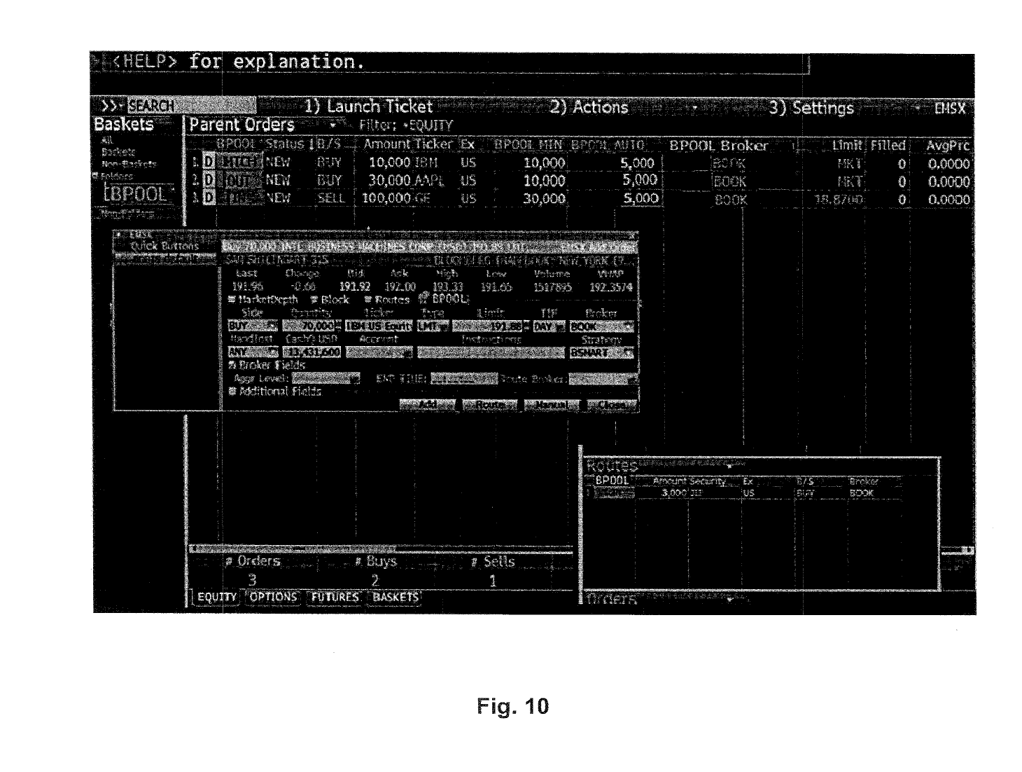

In FIGS. 10-12, “BPOOL” refers to a liquidity system.

FIG. 10 depicts an exemplary screenshot of a trading screen that may be used to enter and display order information, liquidity system information, and requests to firm up orders. In some embodiments, the trading screen may be a blotter view, or a blotter view with one or more pop-up windows representing other information.

In the exemplary screenshot of FIG. 10, three orders are depicted as existing in the trader's blotter. A “BPOOL” column on the far left indicates whether orders are (1) matched in the liquidity system or the execution venue (in a first color, e.g., orange, alerting of a potential invitation to firm up or execution); (2) not participating in the liquidity system (in another color, e.g., gray); or (3) participating in the liquidity system, but not yet matched (in still another color, e.g., blue). Other columns may display information related to each order, e.g., order status, side (i.e., buy or sell), ticker symbol, size indications (which may include minimum and maximum desired numbers of shares), a broker ID, and a price limit. In FIG. 10, “Book” refers to an ATS order.

As discussed above, a request to trader workstation 144, including a calculated number of shares to trade, may appear to the trader workstation 144 as a pop-up window (and/or another indicator, e.g., as described above) on the trader's display. Alternatively, the trader's system may be configured to respond to requests automatically, e.g., based on pre-defined logic or rules, without a popup. Referring to the latter embodiment, in the exemplary screenshot of FIG. 10, the “BPOOL AUTO” field may be used to indicate the total cumulative shares that are available for such an “auto-match” without a popup that requests share reallocation information, e.g., with or without a pop-up requesting trader confirmation.

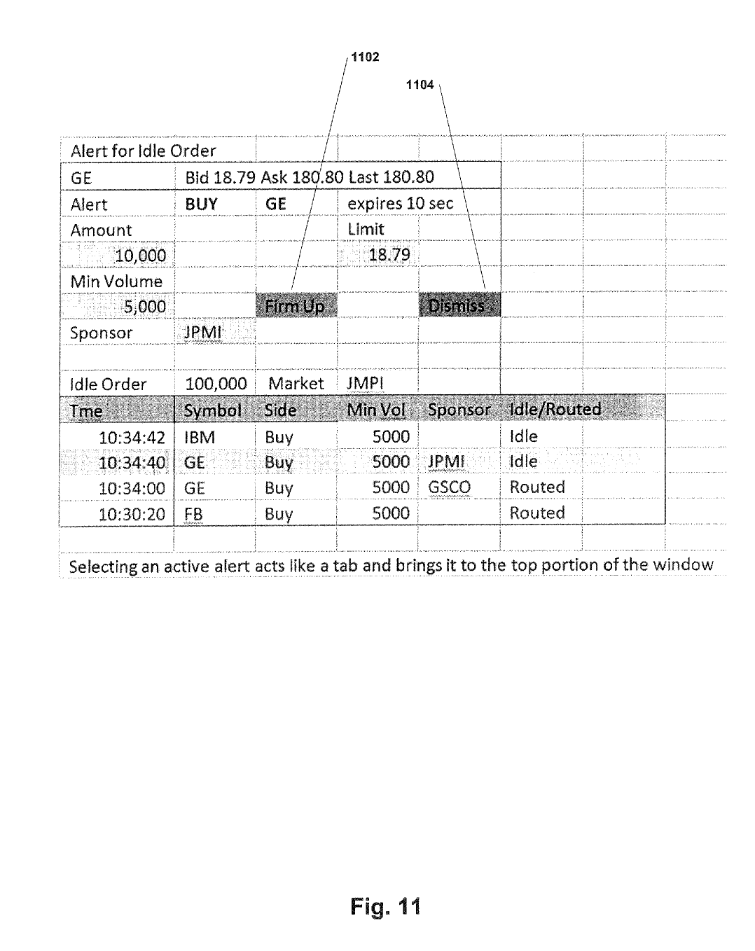

FIG. 11 depicts an exemplary screenshot of a trading screen that may be used to firm up or reallocate uncommitted order quantity. The screenshot of FIG. 11 displays an alert for IBM, two alerts for GE, and one alert for Facebook (FB), with the first alert for GE highlighted as selected/active with information displayed associated therewith below the column header or bar, for example, side, expiration, amount, limit, minimum volume, and sponsor. “Idle” refers to uncommitted. Above the bar, two buttons, “Firm Up” 1102 and “Dismiss” 1104 may be selected to either firm up an order, or to dismiss the alert.

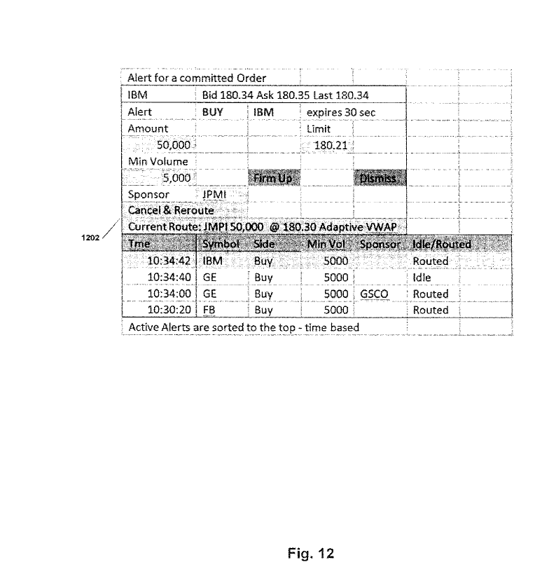

FIG. 12 depicts an exemplary screenshot of a trading screen that may be used to firm up or reallocate committed quantity. FIG. 12 shares many of the elements of FIG. 11 discussed above, and adds a “Cancel & Reroute” 1202 indicator, displayed next to the current route. If a trader selects the “Dismiss” button, the alert will be dismissed. If the trader selects the “Firm Up” button, the order will be firmed up in accordance with the displayed cancel and reroute instructions, i.e., re-routing to broker “JPMI.” In an embodiment where shares have been committed to more than one brokers, the trader may receive a pop-up window (not shown) (and/or another indicator, e.g., as described above) that also asks for selection of a method, e.g., FIFO, LIFO, pro rata, etc. for deciding which shares are pulled back from the respective brokers, before proceeding with the “cancel and reroute” and firm-up steps.

Embodiments of the invention and variations thereof have been disclosed by way of example and not limitation. Modifications and further variations of the structure and functionality will be evident to persons skilled in the applicable arts from the disclosure herein.

1. A method of facilitating electronic trading of financial interests over an electronic network, the method comprising:
sending from at least one computer, through the network, a first order for a financial interest, the first order being stored in at least one storage device accessible by the at least one computer and being an order for the financial interest that is not presently executable in an execution venue but has associated therewith a quantity or quantities that can be committed to a possible trade in the execution venue;
receiving, though the network, information that indicates a potential match between the first order and a second order for the financial interest, the second order being either immediately executable in the execution venue or not immediately executable in the execution venue but having associated therewith a quantity or quantities that can be committed to an order available for a possible trade in the execution venue;
determining, with the assistance of at least one computer, to reallocate to a third order for the financial interest, for possible trade in the execution venue, at least a quantity that was previously committed to at least one broker; and
in response to determining to reallocate the quantity to the third order, at least one computer initiating a firming-up process to enable a possible trade of orders for the financial interest in the execution venue.

2. The method of claim 1, comprising receiving the first order from an OMS or EMS that is associated with a trader workstation, wherein the firming-up process comprises:
sending to the trader workstation, through the network, an invitation to firm up the first order; and
receiving from the trader workstation, through the network, confirmation that a quantity of the financial interest to be committed to the third order has been locked down.

3. The method of claim 2, comprising:
automatically mirroring a plurality of the orders from the OMS or EMS for storage in the storage device, the first order being one of the mirrored orders.

4. The method of claim 2, comprising automatically calculating a total quantity to be reallocated, wherein the invitation to firm up the first order includes an invitation to commit the total reallocated quantity in a firm order, the firm order being the third order and the total reallocated quantity including the quantity previously committed to the at least one broker.

5. The method of claim 4, wherein the invitation to firm up the first order comprises an invitation to reallocate and commit to the third order at least one quantity that has previously been committed to the broker, wherein the invitation identifies the broker that is associated with the quantity.

6. The method of claim 4, comprising receiving through the network, from the trader workstation, information that identifies a broker to give up to the execution venue when sending the third order to the execution venue.

7. The method of claim 1, wherein:
the information that indicates a potential match between the first order and the second order signifies that an order has been identified as a potential contra order to the first order for trading at the execution venue; and
the execution venue is a dark pool.

8. A method of facilitating electronic trading of financial interests over an electronic network, the method comprising:
sending from at least one computer, through the network, a first order for a financial interest, the first order being stored in at least one storage device accessible by the at least one computer and being an order for the financial interest that is not presently executable in an execution venue but has associated therewith a quantity or quantities that can be committed to a possible trade in the execution venue;
receiving, though the network, information that indicates a potential match between the first order and a second order for the financial interest, the second order being either immediately executable in the execution venue or not immediately executable in the execution venue but having associated therewith a quantity or quantities that can be committed to an order available for a possible trade in the execution venue;
automatically determining that at least a quantity that was previously committed to at least one broker remains available for trading;
in response to determining that the quantity remains available for trading, determining with the assistance of at least one computer to reallocate to a third order for the financial interest, for possible trade in the execution venue, the quantity that remains available for trading; and
in response to determining to reallocate the quantity to the third order, at least one computer initiating a firming-up process to enable a possible trade of orders for the financial interest in the execution venue.

9. The method of claim 8, comprising receiving the first order from an OMS or EMS that is associated with a trader workstation, wherein the firming-up process comprises:
sending to the trader workstation, through the network, an invitation to firm up the first order; and
receiving from the trader workstation, through the network, confirmation that a quantity of the financial interest to be committed to the third order has been locked down.

10. The method of claim 9, comprising:
automatically mirroring a plurality of the orders from the OMS or EMS for storage in the storage device, the first order being one of the mirrored orders.

11. The method of claim 9, comprising automatically calculating a total quantity to be reallocated, wherein the invitation to firm up the first order includes an invitation to commit the total reallocated quantity in a firm order, the firm order being the third order and the total reallocated quantity including the quantity previously committed to the at least one broker.

12. The method of claim 11, wherein the invitation to firm up the first order comprises an invitation to reallocate and commit to the third order at least one quantity that has previously been committed to the broker, wherein the invitation identifies the broker that is associated with the quantity.

13. The method of claim 9, comprising receiving through the network, from the trader workstation, information that identifies a broker to give up to the execution venue when sending the third order to the execution venue.

14. The method of claim 8, wherein:
the information that indicates a potential match between the first order and the second order signifies that an order has been identified as a potential contra order to the first order for trading at the execution venue; and
the execution venue is a dark pool.

15. A method of facilitating electronic trading of financial interests over an electronic network, the method comprising:
sending from at least one computer, through the network, a first order for a financial interest, the first order being received from an OMS or EMS that is associated with a trader workstation, being stored in at least one storage device accessible by the at least one computer, and being an order for the financial interest that is not presently executable in an execution venue but has associated therewith a quantity or quantities that can be committed to a possible trade in the execution venue;
receiving, though the network, information that indicates a potential match between the first order and a second order for the financial interest, the second order being either immediately executable in the execution venue or not immediately executable in the execution venue but having associated therewith a quantity or quantities that can be committed to an order available for a possible trade in the execution venue;
determining, with the assistance of at least one computer, to reallocate to a third order for the financial interest, for possible trade in the execution venue, at least a quantity that was previously committed to at least one broker;
determining that the trader workstation has relationships with two or more sponsoring brokers; and
in response to determining to reallocate the quantity to the third order, at least one computer initiating a firming-up process to enable a possible trade of orders for the financial interest in the execution venue, the firming-up process comprising (i) sending to the trader workstation, through the network, an invitation to firm up the first order, and (2) receiving from the trader workstation, through the network, (i) confirmation that a quantity of the financial interest to be committed to the third order has been locked down and (ii) information that identifies one of the sponsoring brokers to give up to the execution venue when sending the third order to the execution venue.

16. The method of claim 15, comprising:
automatically mirroring a plurality of the orders from the OMS or EMS for storage in the storage device, the first order being one of the mirrored orders.

17. The method of claim 15, comprising automatically calculating a total quantity to be reallocated, wherein the invitation to firm up the first order includes an invitation to commit the total reallocated quantity in a firm order, the firm order being the third order and the total reallocated quantity including the quantity previously committed to the at least one broker.

18. The method of claim 17, wherein the invitation to firm up the first order comprises an invitation to reallocate and commit to the third order at least one quantity that has previously been committed to the broker, wherein the invitation identifies the broker that is associated with the quantity.

19. The method of claim 15, wherein:
the information that indicates a potential match between the first order and the second order signifies that an order has been identified as a potential contra order to the first order for trading at the execution venue; and
the execution venue is a dark pool.
